(19) United States
(12) Patent Application Publication
(10) Pub. No.: US 2019/0311258 A1
(43) Pub. Date: Oct. 10, 2019

(54) DATA DEPENDENT MODEL INITIALIZATION

(71) Applicant: Microsoft Technology Licensing, LLC, Redmond, WA (US)

(72) Inventors: Lei ZHANG, Bellevue, WA (US); Rong XIAO, Bellevue, WA (US); Christopher BUEHLER, Seattle, WA (US); Anna Samantha ROTH, Bellevue, WA (US); Yandong GUO, Bellevue, WA (US); Jianfeng WANG, Bellevue, WA (US)

(21) Appl. No.: 15/945,888

(22) Filed: Apr. 5, 2018

(51) Int. Cl. G06N 3/08; G06N 3/04

(52) U.S. Cl. CPC G06N 3/08; G06N 3/04

(57) ABSTRACT

Strategies for improved neural network fine tuning. Parameters of the task-specific layer of a neural network are initialized using approximate solutions derived by a variant of a linear discriminant analysis algorithm. One method includes: inputting training data into a deep neural network having an output layer from which output is generated in a manner consistent with one or more classification tasks; evaluating a distribution of the data in a feature space between a hidden layer and the output layer; and initializing, non-randomly, the parameters of the output layer based on the evaluated distribution of the data in the feature space.

### BACKGROUND

Deep learning architectures have found use in pattern matching applications due to their ability to identify patterns in data sets, which is a task to which they are particularly well suited. Consequently, these architectures comprise the engines behind many computer-implemented recognition systems, including those in the fields of natural language processing, computer vision, object recognition, speech recognition, audio recognition, image processing, social network filtering, machine translation, bioinformatics and drug design.

Generally, a neural network comprises an interconnected, layered set of nodes (or neurons) that exchange messages with each other. These connections have numeric weights which indicate the strength of connection between nodes. These weights can be “tuned” via a training process in which a training algorithm is applied to a set of training data and the values of the weights are iteratively adjusted. As a result, neural networks are capable of learning.

A deep neural network (DNN), a type of neural network, typically comprises a plurality of levels (i.e., multiple layers of nodes) between the input and output layers. DNNs are powerful discriminative tools for modeling complex non-linear relationships in large data sets.

DNN training typically involves solving a non-convex optimization problem over many parameters, with no analytical solutions. When training a DNN model to process large-scale training data, it is known to train the DNN model from scratch with an iterative solver. In contrast, when training a DNN model for a specific task, which tends to have training data of smaller scale, fine-tuning (sometimes called transfer learning) is known.

In conventional fine-tuning, parameters of the lower level layers of the DNN model to be trained are initialized to have the same value as a pre-trained model, which has the same structure and trained for general purpose classification, while the parameters of the last layer are set to be random numbers sampled from certain distributions (usually Gaussian).

### BRIEF SUMMARY

This Brief Summary is provided to introduce a selection of concepts in simplified form. It is intended to provide basic understandings of some aspects of the disclosed, innovative subject matter. Its sole purpose is to present some concepts in a simplified form as a prelude to the more detailed description that is presented later. The introduced concepts are further described below in the Description.

This Brief Summary is not an extensive overview of the disclosed, innovative subject matter. Also, it is neither intended to identify “key,” “necessary,” or “essential” features of the claimed subject matter, nor is it intended to limit the scope of the claimed subject matter.

Innovations described herein generally pertain to strategies and techniques for training deep neural networks (DNN). The strategies and techniques yield both faster and improved training of DNNs.

Innovations described herein also generally pertain to strategies and techniques for training DNNs for use in performing specific tasks, such as image recognition, which includes image classification, image/object detection, and image segmentation.

Further, innovations described herein generally pertain to strategies and techniques for improving fine-tuning training strategies for training DNNs for use in performing specific tasks, such as image recognition and object detection.

Still further, innovations described herein include strategies and techniques for improved, non-random initializing of the task-oriented last layer of a DNN to be trained for use in performing specific task, which reduces the training costs (e.g., time and resources) with only negligible associated initialization costs.

According to an aspect of the present invention, there is provided a method of training a deep neural network. The method includes inputting training data into a deep neural network having multiple layers that are parameterized by a plurality of parameters, the multiple layers including an input layer that receives training data, an output layer from which output is generated in a manner consistent with one or more classification tasks, and at least one hidden layer that is interconnected with the input layer and the output layer, that receives output from the input layer, and that outputs transformed data to a feature space between the at least one hidden layer and the output layer. The method also includes: evaluating a distribution of the data in the feature space; and initializing, non-randomly, the parameters of the output layer based on the evaluated distribution of the data in the feature space.

According to another aspect of the present invention, there is provided a method of computing initializing parameters of a task-specific layer of a deep neural network. The deep neural network includes: a task-specific layer from which output is generated in a manner consistent with one or more image recognition tasks; and at least one hidden layer that is connected to the output layer and that outputs transformed data to a feature space between the at least one hidden layer and the task-specific layer. The method includes: determining one or more tasks of the task-specific layer; and estimating initializing values for parameters of the task-specific layer by finding an approximate solution to each of the one or more classification tasks, based on the data distribution in the feature space.

According to still another aspect of the present invention, there is provided a system that includes: an artificial neural network; and level initializing logic. The artificial neural network includes: an input level of nodes that receives the set of features and applies a first non-linear function to the set of features to output a first set of modified values; a hidden level of nodes that receives the first set of modified values and applies an intermediate non-linear function to the first set of modified values to obtain a first set of intermediate modified values; and an output level of nodes that receives the first set of intermediate modified values, and generates a set of output values, the output values being indicative of a pattern relating to the image recognition tasks of the output level. The level initializing logic non-randomly initializes the parameters of the output level by resolving approximate solutions to the last layer, based on data distribution in the feature space.

Furthermore, the present invention may be embodied as a computer system, as any individual component of such a computer system, as a process performed by such a computer system or any individual component of such a computer system, or as an article of manufacture including computer storage with computer program instructions and which, when processed by computers, configure those computers to provide such a computer system or any individual component of such a computer system. The computer system may be a distributed computer system. The present invention may also be embodied as software or processing instructions.

These, additional, and/or other aspects and/or advantages of the present invention are: set forth in the detailed description which follows; possibly inferable from the detailed description; and/or learnable by practice of the present invention. So, to the accomplishment of the foregoing and related ends, certain illustrative aspects of the claimed subject matter are described herein in connection with the following description and the annexed drawings. These aspects are indicative of various ways in which the subject matter may be practiced, all of which are within the scope of the claimed subject matter. Other advantages, applications, and novel features may become apparent from the following detailed description when considered in conjunction with the drawings.

### BRIEF DESCRIPTION OF THE DRAWINGS

The accompanying drawings, which are incorporated herein and form part of the specification, illustrate aspects of the present invention and, together with the description, further serve to explain principles of the present invention and to enable a person skilled in the relevant art(s) to make and use the invention. These aspects are consistent with at least one embodiment of the present invention.

FIG. 1A is a high-level illustration of a learning system for generating structured data that is consistent with the conventional art.

FIG. 1B is a high-level illustration of the DNN of the learning system of FIG. 1A.

FIG. 2 is a high-level illustration of a modified arrangement of the learning system of FIG. 1A that is consistent with the conventional art.

FIG. 3 is an example of a multi-layered DNN that is trainable in a manner that is consistent with one or more embodiments of the present invention.

FIG. 4 is a flowchart illustrating a method of preparing a learning system for operation.

FIG. 5A is a flowchart illustrating a method of resolving initial parameters of a task-oriented output layer of a DNN, which is consistent with one or more embodiments of the present invention.

FIG. 5B is a flowchart illustrating block 520 of FIG. 5A.

FIG. 6 is a flowchart illustrating a method of fine-tuning a DNN, which is consistent with one or more embodiments of the present invention.

FIG. 7 is a schematic illustration of an exemplary computing device that may be used in accordance with the systems and methodologies disclosed herein.

FIG. 8 is a schematic illustration of an exemplary distributed computing system that may be used in accordance with the systems and methodologies disclosed herein.

### DESCRIPTION

Preliminarily, some of the figures describe one or more concepts in the context of one or more structural components, variously referred to as functionality, modules, features, elements, etc. The various components shown in the figures can be implemented in any manner, for example, by software, hardware (e.g., discrete logic components, etc.), firmware, and so on, or any combination of these implementations. In one case, the illustrated separation of various components in the figures into distinct units may reflect the actual use of corresponding distinct components. Additionally, or alternatively, any single component illustrated in the figures may be implemented by plural components. Additionally, or alternatively, the depiction of any two or more separate components in the figures may reflect different functions performed by a single component.

Others of the figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). The blocks shown in the flowcharts can be implemented by software, hardware (e.g., discrete logic components, etc.), firmware, manual processing, etc., or any combination of these implementations.

The various aspects of the inventors' innovative discoveries are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents and alternatives falling within the spirit and scope of the claimed subject matter.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of persons skilled in the relevant art(s) to implement such feature, structure, or characteristic in connection with other embodiments whether or not explicitly described.

As to terminology, the phrase “configured to” is both contemplated and to be understood to encompass any way that any kind of functionality can be constructed to perform an identified operation. The functionality can be configured to perform an operation using, for instance, software, hardware (e.g., discrete logic components, etc.), firmware etc., or any combination thereof.

The term “logic” is both contemplated and to be understood to encompass any functionality for performing a task. For instance, each operation illustrated in the flowcharts corresponds to logic for performing that operation. An operation can be performed using, for instance, software, hardware (e.g., discrete logic components, etc.), firmware, etc., or any combination thereof. So, references to logic includes references to components, engines, and devices.

The term “computing device” is both contemplated and to be understood to encompass any processor-based electronic device that is capable of executing processing instructions to provide specified functionality. Examples include desktop computers, laptop computers, tablet computers, server computers, multiprocessor systems, microprocessor-based systems, network PCs, minicomputers, and mainframe computers. Additional examples include programmable consumer electronics, appliances, especially so-called “smart” appliances such as televisions. Still other examples include devices that are wearable on the person of a user or carried by a user, such as cellphones, personal digital assistants (PDAs), smart watches, voice recorders, portable media players, handheld gaming consoles, navigation devices, physical activity trackers, and cameras. Yet another non-limiting example is a distributed computing environment that includes any of the above types of computers or devices, and/or the like.

The term “example” and the phrases “for example” and “such as” are to be understood to refer to non-limiting examples. Also, any example otherwise proffered in this detailed description are both intended and to be understood to be non-limiting.

The term “data” is both contemplated and to be understood to encompass both the singular and plural forms and uses.

The phrase “structured” data is both contemplated and to be understood to encompass information with a high degree of organization. Examples of typically structured data includes ordered data, partially ordered data, graphs, sequences, strings, or the like.

The phrase “data store” is both contemplated and to be understood to encompass any repository in which data is stored and may be managed. Examples of such repositories include databases, files, and even emails.

The phrase “communication media” is both contemplated and to be understood to encompass media that embody computer-readable instructions, data structures, program modules or other data in a modulated data signal such as a carrier wave.

The phrases “computer program medium,” “storage media,” “computer-readable medium,” and “computer-readable storage medium,” as used herein, are both contemplated and to be understood to encompass memory devices or storage structures such as hard disks/hard disk drives, removable magnetic disks, removable optical disks, as well as other memory devices or storage structures such as flash memory cards, digital video disks, random access memories (RAMs), read only memories (ROM), and the like. Such computer-readable storage media are distinguished from and non-overlapping with communication media (do not include communication media).

The term “cloud” is both contemplated and to be understood to encompass a system that includes a collection of computing devices, which may be located centrally or distributed, that provide cloud-based services to various types of users and devices connected via a network, such as the Internet.

The phrase “deep neural network” or (DNN) is both contemplated and to be understood to encompass a type of an artificial neural network (ANN) with multiple hidden layers, including input and output layers and in which data flows from the input layer to the output layer without looping back. A DNN can have at least two hidden layers. A neural network trained using techniques described herein can have one hidden layer, two hidden layers, or more than two hidden layers.

The phrase “Softmax function” is both contemplated and to be understood to encompass a normalized exponential function that is used in the final layer of a neural network-based classifier.

Still further, it is to be understood that instances of the terms “article of manufacture,” “process,” “machine,” and/or “composition of matter” in any preambles of the appended claims are intended to limit the claims to subject matter deemed to fall within the scope of patentable subject matter defined by the use of these terms in 35 U.S.C. § 101.

Conventional fine-tuning training strategies for DNNs, although widespread and somewhat successful, nonetheless suffer from inherent drawbacks and inefficiencies because the last layer is randomly initialized. Thus, they are often very time-consuming and not entirely satisfactory. Furthermore, these drawbacks and inefficiencies may limit the implementation of these strategies in, for example, distributed computing systems (i.e., cloud implementations).

A first drawback of conventional fine-tuning strategies is a problem of overfitting. In machine learning, overfitting occurs when a statistical model describes random error or noise instead of the underlying relationship. Overfitting generally occurs when a model is excessively and/or unnecessarily complex (i.e., more complicated than is ultimately optimal), such as having too many parameters relative to the number of observations.

A consequence of overfitting is that performance on the training examples still increases while the performance on unseen data becomes worse. Thus, a model that has been overfit generally has poor predictive performance, as it can exaggerate minor fluctuations in the data.

Overfitting is especially common when training is performed for too long or when training examples are rare, causing the DNN to adjust to very specific random features of training data that have no causal relation to the target function.

Conventional fine-tuning strategies successfully leverage low level visual pattern extractors learned from general tasks, which only partially reduce over-fitting.

A second challenge is DNN learning speed.

For relatively simple tasks, fine-tuning can be accomplished in a satisfactory timeframe. For more complex tasks, such as object detection, conventional fine-tuning can require hours or even days, which is impractical for applications that require frequent model training or prototyping. Until recently, such long timeframes were not problematic. Recent cloud implementations of learning architectures, such as DNNs, however, require shorter timeframes.

For example, for a web-based training service like Microsoft Custom Vision®, the DNN model needs to be trained on the order of minutes so as to reasonably guarantee a satisfactory user experience. This is because a reasonable web session does not typically extend for days or even weeks, which is commonly the timeframe for conventional fine-tuning methods. Consequently, the long timeframes of conventional fine-tuning are an impediment to cloud implementations. Conversely, DNN training on the order of minutes could make successful training during a single web session possible.

The inventors have discovered a novel approach to fine-tuning that avoids the inefficiencies that plague conventional DNN model fine-tuning strategies. In particular, the inventors' novel approach does not randomly initialize the parameters of the last layer. Instead, the present inventors have discovered a novel way to initialize DNN models by estimating values of the parameters of the last layer of the DNN model to be trained. Also, this estimating is based on the training data and the task(s) of the last layer. Thus, it can be accurate to characterize this estimating, and this model initialization as a whole, as data dependent.

One consequence of this novel approach is that it is not constrained to the low learning rate for the parameters in the non-linear feature extraction layers, which are required in conventional approaches so that the randomly initialized parameters in the last layer do not ruin the pre-trained model. Further, the results of the initializing are close to the optimal solution to each classification task. Usually, after model initialization, further fine-tuning the model can give an additional 1-2% gain in accuracy when the parameters in the feature extraction layers are fixed.

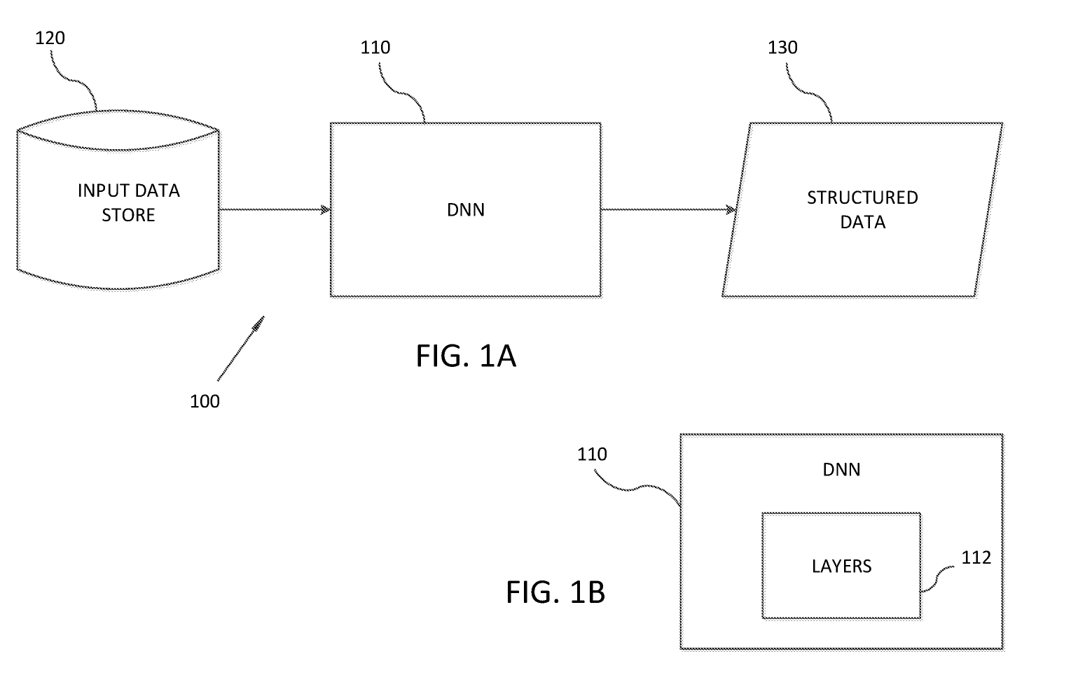

Referring now to FIG. 1A, there is illustrated, at a high-level, a learning system 100 for generating structured data.

The system 100 includes a trained DNN 110, an input data store 120, and a set of output structured data 130. The DNN 110 is a type of deep learning model.

The input data store 120 contains data to be input into and processed by the DNN 110. This data represents an input of unsorted (i.e., unstructured) data. The structured data 130 represents output of the DNN 110 and reflects a classification task of the DNN (e.g., image recognition tasks). This structured data 130 can be used by other components or presented to a user, or both, for example.

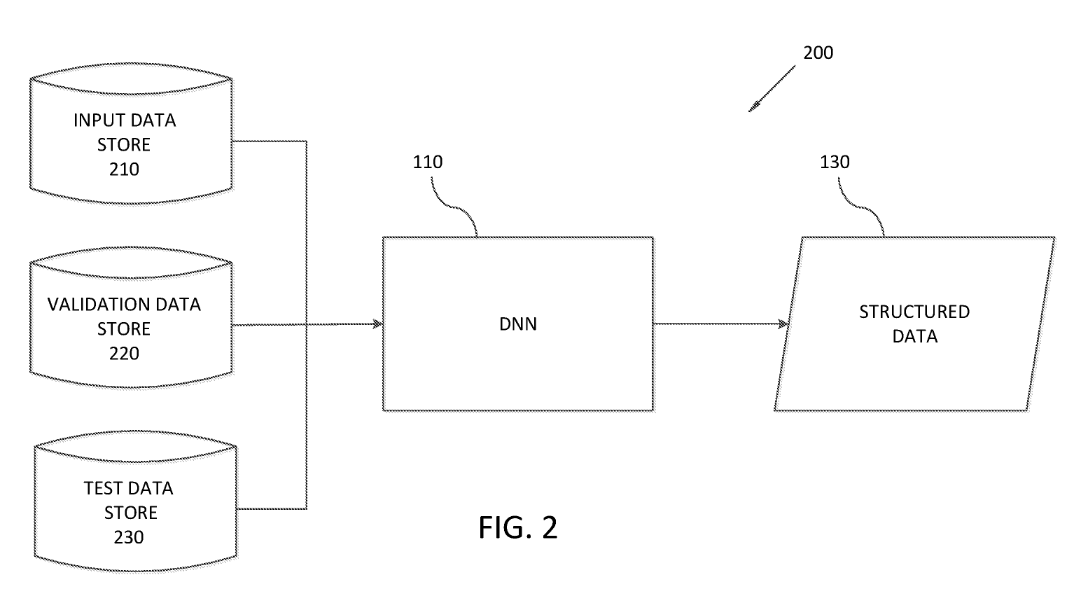

In general, learning systems like system 100 have multiple phases of operation, which are discussed in more detail with reference to FIG. 2.

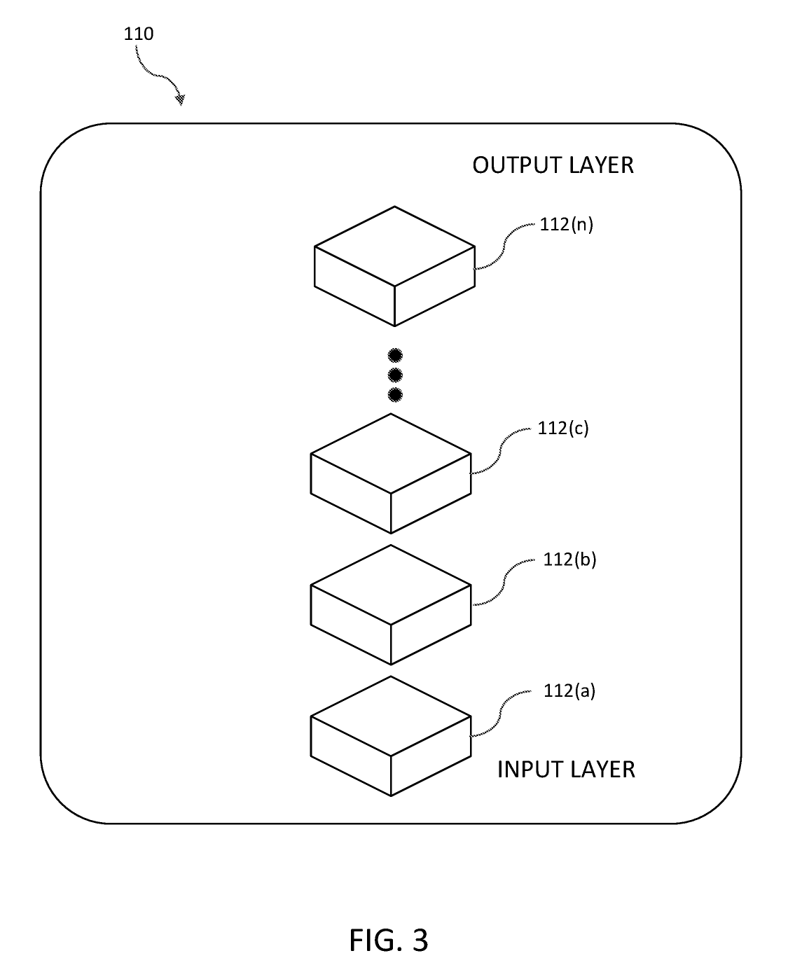

Referring to FIG. 1B, the DNN 110 is illustrated at a high-level so as to convey and confirm the layered structure 112 thereof, which will be described in more detail below with reference to FIG. 3.

Referring now to FIG. 2, there is illustrated, at a high-level, an alternative configuration of a learning system 200. In the learning system 200, the single data store 120 of FIG. 1A is replaced with the following three data stores: an input data store 210; a validation data store 220; and a test data store 230.

Learning systems, like system 200, have three primary phases of operation.

An initial phase is typically known or accurately characterized as a training phase. During the training phase, a set of training data can be input into the learning system and the learning system learns to optimize processing of the received training data.

Next, during what is typically known or accurately characterized as a validation phase, a set of validation data can be input into the learning system. The results of processing of the validation data set by the learning system can be measured using a variety of evaluation metrics to evaluate the performance of the learning system. Here, the learning system can alternate between the training and validation data to optimize system performance. Once the learning system achieves a desired level of performance, the parameters of the learning system can be fixed such that performance will remain constant before the learning system enters into the operational phase.

Then, during what is typically known or accurately characterized as an operational phase, which typically follows both training and validation, users can utilize the learning system to process operational data and obtain the users' desired results.

In operation, the DNN 110 may receive data respectively from the separate data stores (210-230) depending upon the mode or phase of operation. The DNN 110 can receive a data set specifically selected for training the DNN from a training data store 210 during the training phase. The DNN 110 can receive a validation data set from a validation data store 220 during a validation phase. In addition, the DNN 110 can receive data from a separate test data store 230, during the operational phase. So, during the operational phase, the DNN 110 processes data from the input data store 210 and outputs structured data 130.

Referring now to FIG. 3, there is illustrated an example of deep neural network 110, which is trainable in a manner that is consistent with one or more embodiments of the present invention. The DNN 110 may be used in the learning systems 100 or 200 of FIGS. 1A and 2, for example.

Generally, the DNN 110 is a type of ANN with multiple hidden layers between respective input and output layers. A shared characteristic of DNNs, including DNN 110, is that they are feedforward networks in which data flows from the input layer to the output layer without looping back. Deep neural networks excel at modeling complex non-linear relationships.

The DNN 110 of FIG. 3 is a multi-layer neural network that includes an input (bottom) layer 112(a) and an output (top) layer 112(n), along with multiple hidden layers, such as the multiple layers 112(b)-112(c). Here, n denotes any integer.

The layers 112(a)-112(n) may be conceptually described as being stacked. Generally, the lower layers of DNN 110 (layers closer to 112(a)) operate on lower level information while higher layers (layers closer to 112(n)) operate on higher level information. So, for example, in an image recognition context, lower layers of DNN 110 may identify edges of images while higher layers may identify specific, categorizing shapes and/or patterns. Also, for example, in an object detection environment, lower level information may comprise edge information while higher level information might comprise shapes with specific attributes (e.g., color and location).

Further, each hidden layer comprises a respective plurality of nodes. Further, each node in a hidden layer is configured to perform a transformation on output of at least one node from an adjacent layer in the DNN. This flow reflects the feedforward nature of the DNN.

Additionally, the hidden layers may be collectively optimized using stochastic gradient descent (“SGD”), which is a stochastic approximation of the gradient descent optimization and iterative method for minimizing an objective function that is written as a sum of differentiable functions.

In the conceptual separation between output layer 112(n) and the immediately preceding hidden layer (112(n−1) (not illustrated) defines a feature space. In more detail, hidden layer 112(n−1) transforms inputs into feature space, which makes them linearly classifiable, for example. This is because feature space comprises collections of features that are used to selectively characterize data. For example, if input data is about people, a feature space might include: gender, height, weight, and/or age.

In sum, the DNN 300 is a multi-layered construct that includes: an input layer that receives data (112(a)); an output layer that outputs structured data (112(n)); and a plurality of hidden layers (112(b) and 112(c)) disposed between the input and output layer.

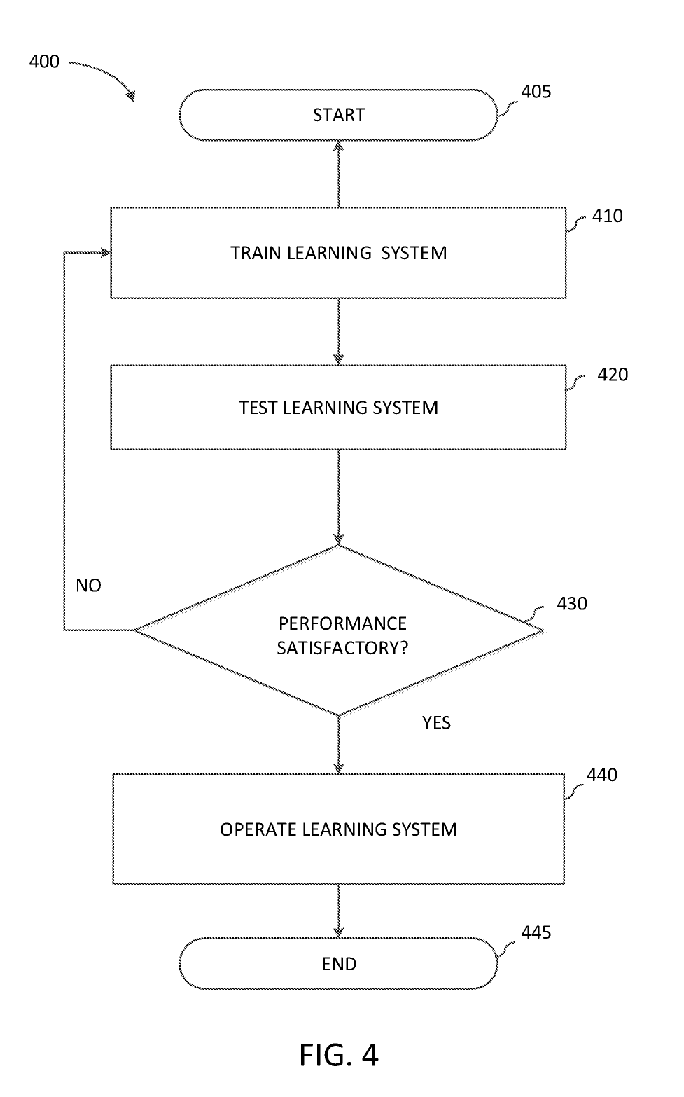

FIG. 4 illustrates a method 400 for preparing a learning system (e.g., system 100 of FIG. 1) for operation, in a manner consistent with one or more embodiments of the present invention.

Processing begins at the START block 405 and continues to process block 410 where the learning system is trained. At process block 420, the learning system is tested using validation data. At decision block 430, a determination is made as to whether the performance of the learning system over the validation data is sufficient. If the performance is deemed insufficient, the processing returns to process block 410 and the learning system continues training. If the performance of the learning system is sufficient, processing continues to process block 440 where the learning system enters the operational phase and can be utilized by users. The process terminates at END block 445.

By the foregoing operations, operating parameters of a learning system, such as a DNN, can be fixed prior to entering into the operational phase.

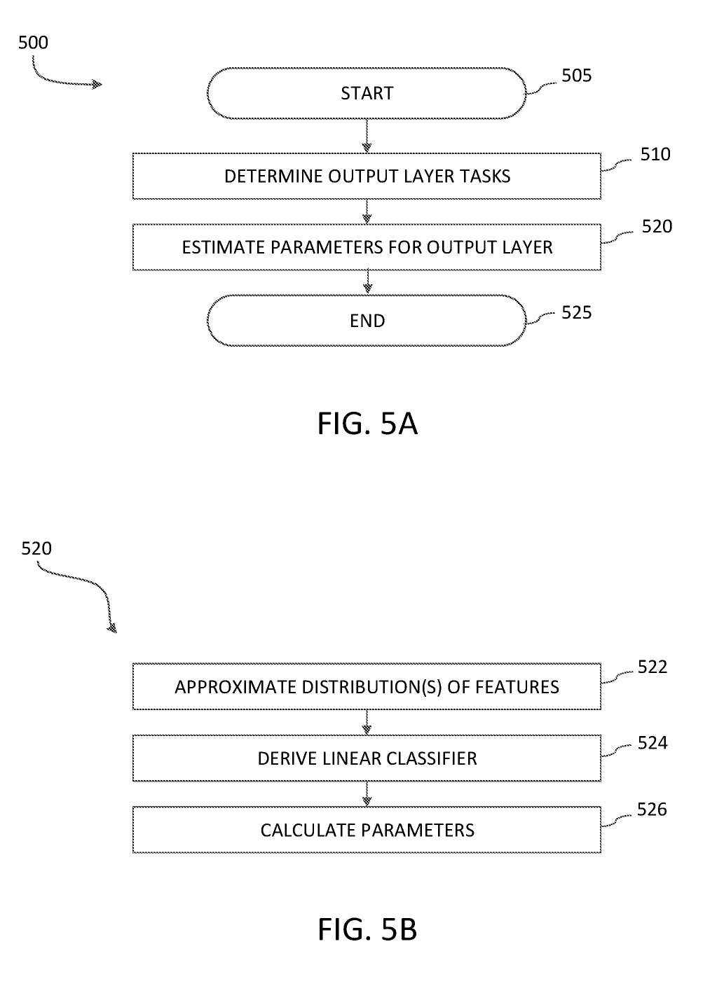

Referring now to FIG. 5A, there is illustrated a method 500 of resolving initializing parameters of the last layer of a DNN model, which is consistent with one or more embodiments of the present invention.

In brief, the inventors have proved (both theoretically and experimentally) that the distribution of the features for each class of data can be approximated by multiple Gaussian distributions with a shared covariance but with different means. Then, they derive an optimal linear classifier based on this discovery, which is then used to initialize the parameters of the last layer of the DNN model. It is to be appreciated that these improved initial parameters yield less sensitive learning parameters, such as weight decay.

Processing begins at the START block 505 and continues to process block 510, in which one or more tasks of the output layer is determined. For example, in an image recognition context, the task of the output layer may be a classification task to identify a particular object in one or more stored images. The problem to which the DNN is applied dictates the different categories of data and the meanings thereof.

Next, at block 520, values for the parameters of the output layer are estimated. These parameters may be estimated by finding approximate solution(s) to respective the one or more classification tasks identified in block 510. Further, these classification tasks can be based on how data is distributed in the feature space of the DNN, which is defined by the output layer and the hidden layer that immediately precedes that layer.

Thereafter, the process terminates at END block 525.

Block 520 is discussed in more detail with reference to FIG. 5B.

As FIG. 5B illustrates, block 520 may be achieved by executing the following series of operations:

approximate a distribution of features for each class of data (block 522);

derive an optimal linear classifier based on the distribution (block 524); and

compute initializing parameters of the last layer of the DNN model using the derived optimal linear classifier (block 526). A logarithmic discussion of block 520 follows.

The inventors have discovered that the cross-entropy with Softmax loss used in image classification has a hidden assumption, which is that different classes in the feature space have respective mean statistics but share higher order statistics. This discovery has been verified both theoretically and experimentally.

Then, based on that assumption, the class centroids μₖ can be computed by the following Equation (1):

$${μ}_{k} = \frac{1}{\vert {C}_{k} \vert} {{Σ}_{i ∈ {C}_{k}}}^{ } {x}_{i} , \qquad ( 1 )$$

where Cₖ is the set of indices of samples belonging to class k, {xᵢ,yᵢ}, i=1, 2, . . . , N, yᵢ∈K denote the features and class labels for the output.

Here, the probability of any testing sample x belonging to a specific class k can be evaluated by the following Equation (2):

$$P ( k \vert x ) = {\vert 2 πΣ \vert}^{- \frac{1}{2}} exp ( \frac{- {( x - {μ}_{k} )}^{T} {Σ}^{- 1} ( x - {μ}_{k} )}{2} ) \qquad ( 2 )$$

Next, class labels can be assigned to the samples so as to maximize the following conditional probability defined by Equation (3):

$$\hat{y} = {argmax}_{k ∈ K} P ( k \vert x ) \qquad ( 3 )$$

Then, by cancelling quadratic terms, Equation (3) can be rewritten as the following Equation (4):

$$\hat{y} = {argmax}_{k} {μ}_{k}^{T} {Σ}^{- 1} x - \frac{1}{2} {μ}_{k}^{T} {Σ}^{- 1} {μ}_{k} \qquad ( 4 )$$

Also, if weights are expressed as Equations (5) and (6):

wₖ=Σ⁻¹μₖ, (5)

bₖ=½wₖ^{T}μₖ (6)

Then, Equation (4) becomes the following Equation (7):

$$\hat{y} = {argmax}_{k ∈ Y} {w}_{k}^{T} x + {b}_{k} \qquad ( 7 )$$

The foregoing confirms that the foregoing Equation (6) provides an optimal solution to a linear classifier for the problem.

Importantly, the present invention avoids the problems of the high variability of covariance matrix estimation in the absence of sufficient training data. This high variable causes the weights estimated by foregoing Equations (5) and (6) to be heavily weighted by the smallest eigenvalues and their associated eigenvectors. The inventors have discovered that introducing a regularization term to the covariance matrix avoids this problem.

The introduction of a regularization term is discussed.

When I is an identity matrix and E is a regularization term, then wₖ=(Σ+∈I)⁻¹μₖ. Also, wₖ can be efficiently calculated by solving the equation for vector z according to the following Equation (8):

(Σ+∈I)z=μᵢ. (8)

Using Equation (8) avoids a need to calculate a matrix inverse. This, in turn, increases freedom of mathematical optimization and training speed.

Implementation of the foregoing novel strategies and techniques in a multi-label classification context is discussed.

One of the conventional solutions for multi-label classification is to train a one-versus-all binary classifier for each class. Using such a formulation, the multi-label classification by a set of binary classification problems can be modeled. For each class i, the weight for the positive samples may be represented by the following Equation (9):

wₖ⁺=Σ⁻¹μₖ (9),

and the weights for the negative samples may be represented by the following Equation (10):

$${w}_{k}^{-} = \frac{{Σ}_{j \neq k} {n}_{j} {w}_{j}^{+}}{{Σ}_{j \neq k} {n}_{j}} , \qquad ( 10 )$$

Where nⱼ is the number of samples in class j. Similarly, the center of the negative samples in class k may be defined by the following Equation (11):

$${μ}_{k}^{-} = \frac{{Σ}_{j \neq k} {n}_{j} {μ}_{j}}{{Σ}_{j \neq k} {n}_{j}} . \qquad ( 11 )$$

Then, the initial weights for the multi-label classification problem can be obtained by the following Equations (12) and (13):

wₖ=wₖ⁺−wₖ⁻, (12);

and

bₖ=½wₖ^{-T}μₖ. (13).

DNN model initialization is discussed.

Generally, when any constant (α) that is greater than 0, β, and a constant vector v, infinite sets of weights and biases { [symbol] , [symbol] } can be defined by the following Equations (14) and (15):

[symbol]

=αwₖ+v (14);

and

[symbol]

=αbk+β (15).

The equivalent performance of the parameters, in accuracy, is provable. Still, their impact on SGD optimization will be different. Here, it is to be appreciated that multi-class logistic regression is implemented in many deep learning platforms as a fully connected layer followed by Softmax with a cross entropy loss layer. When a is increased by ten times, however, the cross-entropy loss after the Softmax operation will be changed, and the loss propagated to previous layers will be changed as well. Still, there is no analytical solution to finding an optimal set of parameters which can minimize the cross entropy loss. So, instead of solving it directly, the weights {w′ₖ} of the last linear layer of a pre-trained DNN can be used as reference.

In more detail, it can be advantageous to have a similar scale of cross entropy loss that propagated through lower layers. So, for ŵ∈{ [symbol] }, \hat{b}∈{ [symbol] }, w′∈{w′ₖ}, and b′∈{b′ₖ}, the following Equations (16)-(18) maybe derived:

E(ŵ))=E(w′) (16)

E(\hat{b})=E(b′) (17)

E(∥ŵ−E(ŵ)∥²)=E(∥w′−E(w′)∥²), (18)

where E(.) is the expectation. Then, from Equation (11) and Equations (16)-(18), the following Equations (19)-(21) may be derived:

$$\begin{matrix}υ = E ( {w}^{′} ) - α E ( w ) & ( 19 ) \\ β = E ( {b}^{′} ) - α E ( b ) & ( 20 ) \\ α = \sqrt{\frac{E ( {‖ w ‖}^{2} - {‖ E ( w ) ‖}^{2}}{E ( {‖ w ′ ‖}^{2} - {‖ E ( w ′ ) ‖}^{2}}} . & ( 21 )\end{matrix}$$

Various contemplated applications of innovations disclosed in this application are discussed. These examples are, of course, non-limiting and for illustrative purposes.

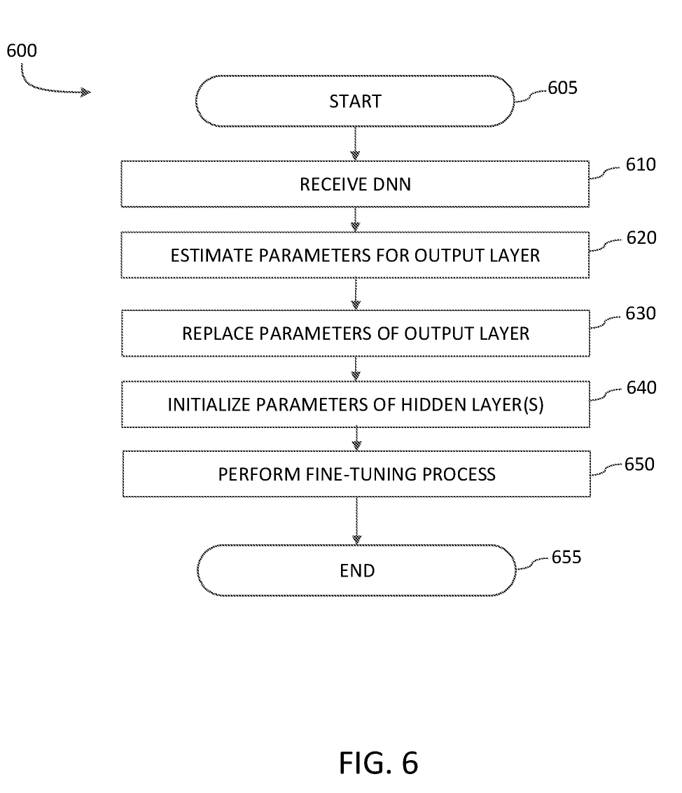

Referring now to FIG. 6, there is illustrated an exemplary method 600 of fine-tuning a DNN model, which is consistent with one or more embodiments of the present invention.

The method 600 begins at START block 605 and proceeds to block 610, in which a DNN, such as DNN 110 of FIG. 3, is received.

Next, at block 620, values for the parameters of the output layer are estimated. These parameters may be estimated by finding approximate solution(s) to the respective one or more classification tasks. Further, these classification tasks can be based on how data is distributed in the feature space. This operation may be performed using method 500 of FIG. 5.

Then, in block 630, the values of the parameters of the output layer are replaced with the calculated values.

In block 640, the values of the parameters of the hidden layers are initialized using estimates and/or solutions from general training models.

In block 650, a fine-tuning training operation, including inputting of training data into the input layer of the DNN, may be performed.

In block 650, during the training, the model bias introduced by logistic regression can be gradually absorbed by the previous non-linear layers, and push the data in the feature space based on the logistic distribution assumption. The method 600 terminates at END block 655.

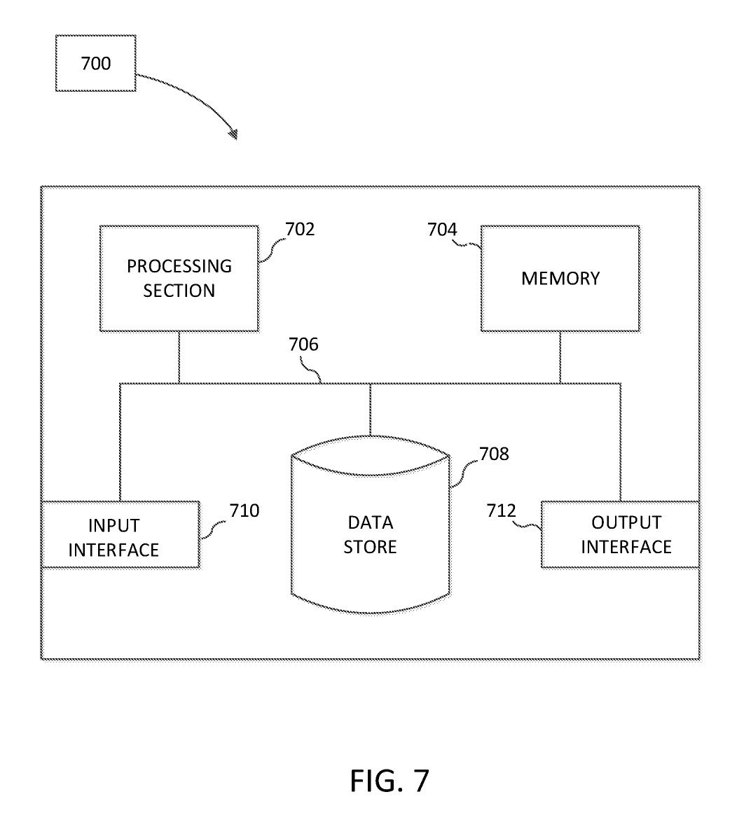

Referring now to FIG. 7, there is illustrated, at a high-level, an exemplary computing device 700 that can be used in accordance with the systems and methodologies disclosed herein. For instance, the computing device 700 may be used in a system that supports training and/or adapting a DNN of a recognition system for a particular user or context.

The computing device 700 includes processing section 702 that executes instructions that are stored in a memory 704. The instructions may be, for instance, instructions for implementing functionality described as being carried out by one or more components discussed above or instructions for implementing one or more of the methods described above. The processing section 702 may access the memory 704 by way of a system bus 706. In addition to storing executable instructions, the memory 704 may also store matrix weights, weight of a regularization parameter, a weight bias, training data, etc. Here, it is to be appreciated that processing section 702 may comprise one or more processors and may embody various logic to execute the methods 500 and 600 of FIGS. 5A and 6.

The computing device 700 additionally includes a data store 708 that is accessible by the processing section 702 by way of the system bus 706. The data store 708 may include executable instructions, learned parameters of a DNN, etc. The computing device 700 also includes an input interface 710 that allows external devices to communicate with the computing device 700. For instance, the input interface 710 may be used to receive instructions from an external computer device, from a user, etc. The computing device 700 also includes an output interface 712 that interfaces the computing device 700 with one or more external devices. For example, the computing device 700 may display text, images, etc. by way of the output interface 712.

It is contemplated that the external devices that communicate with the computing device 700 via the input interface 710 and the output interface 712 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing device 700 in a manner free from constraints imposed by input devices such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth. This input interface 710 permits a user to upload a training data set and/or a DNN model for training, for example.

Additionally, it is to be appreciated that it is both contemplated and possible that the systems and methodologies disclosed herein may be realized via a distributed computing system, rather than a single computing device. Thus, for instance, several devices may be in communication by way of a network connection and may collectively perform tasks described as being performed by the computing device 700.

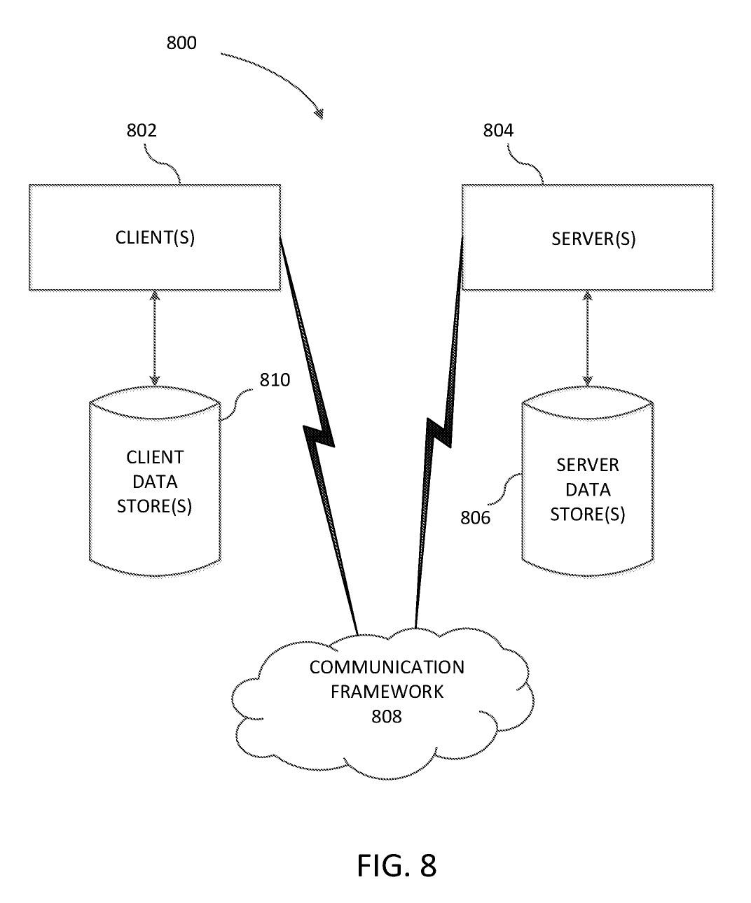

Referring now to FIG. 8, there is illustrated, at a high level, an exemplary distributed computing system 800 such as a so-called “cloud” system.

The system 800 includes one or more client(s) 802. The client(s) 802 can be hardware and/or software (e.g., threads, processes, computing devices). The system 800 also includes one or more server(s) 804. Thus, system 800 can correspond to a two-tier client server model or a multi-tier model (e.g., client, middle tier server, data server), amongst other models. The server(s) 804 can also be hardware and/or software (e.g., threads, processes, computing devices). One possible communication between a client 802 and a server 804 may be in the form of a data packet adapted to be transmitted between two or more computer processes. The system 800 includes a communication framework 808 that can be employed to facilitate communications between the client(s) 802 and the server(s) 804. The client(s) 802 are operably connected to one or more client data store(s) 810 that can be employed to store information local to the client(s) 802. Similarly, the server(s) 804 are operably connected to one or more server data store(s) 806 that can be employed to store information local to the servers 804.

In an exemplary implementation employing the system 800 of FIG. 8, a client (device or user) user transfers or causes to be transferred data to server(s) 804. The server(s) 804 includes at least one processor or processing device (e.g., processing section 702 of FIG. 7) that executes instructions. The instructions may be, for instance, instructions for implementing functionality described as being carried out by one or more components discussed above or instructions for implementing one or more of the methods described above. Here, it is to be appreciated that server(s) 800 would include the logic required to implement the innovative strategies disclosed here, such as the logic required to perform methods 500 of FIG. 5 and method 600 of FIG. 6.

One contemplated implementation of innovations disclosed in this application is in object detection. Another is image recognition.

Various contemplated implementations of innovations disclosed in this application are discussed. These examples are, of course, non-limiting and for illustrative purposes.

One contemplated implementation of innovations disclosed in this application is a computing device. Another contemplated implementation is a fully or partially distributed and/or cloud-based pattern recognition systems.

It is to be appreciated that one or more embodiments of the present invention may include computer program products comprising software stored on any computer useable medium. Such software, when executed in one or more data processing devices, causes a data processing device(s) to operate as described herein. Embodiments of the present invention employ any computer-useable or computer-readable medium, known now or in the future. Examples of computer-readable media include, but are not limited to, memory devices and storage structures such as RAM, hard drives, floppy disks, CD ROMs, DVD ROMs, zip disks, tapes, magnetic storage devices, optical storage devices, MEMs, nanotechnology-based storage devices, and the like.

It is to be appreciated that the functionality of one or more of the various components described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc. Additionally, consistent with one or more contemplated embodiments of the present invention, the digital personal assistant may use any of a variety of artificial intelligence techniques to improve its performance over time through continued interactions with the user. Accordingly, it is reiterated that the disclosed invention is not limited to any particular computer or type of hardware.

It is also to be appreciated that each component of logic (which also may be called a “module” or “engine” the like) of a system such as the systems 100 and/or 200 described in FIGS. 1A and 2 above, and which operate in a computing environment or on a computing device, can be implemented using the one or more processing units of one or more computers and one or more computer programs processed by the one or more processing units. A computer program includes computer-executable instructions and/or computer-interpreted instructions, such as program modules, which instructions are processed by one or more processing units in the one or more computers. Generally, such instructions define routines, programs, objects, components, data structures, and so on, that, when processed by a processing unit, instruct the processing unit to perform operations on data or configure the processor or computer to implement various components or data structures. Such components have inputs and outputs by accessing data in storage or memory and storing data in storage or memory.

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Further, the inventors reiterate and it is to be appreciated that systems consistent with contemplated embodiments of the present invention, such as system 100 of FIGS. 1A and 1B, may be practiced in distributed computing environments where operations are performed by multiple computers that are linked through a communications network. In a distributed computing environment, computer programs may be located in local and/or remote storage media.

As the foregoing illustrates, one or more embodiments described herein advantageously implement a fine-tuning DNN model training schema that is more robust than conventional fine-tuning training schema. It is to be appreciated that during the training, model bias introduced by logistic regression can be gradually absorbed by lower, non-linear layers of the DNN.

As the foregoing illustrates, one or more embodiments described herein advantageously implement a model initialization algorithm that reduces training time and increases accuracy. It is to be appreciated that this is in contrast to the random initialization of parameters in conventional fine-tuning strategies. Further, the non-random initialization of the task-oriented last layer reduces the training costs (e.g., time and resources) with only negligible associated initialization costs. Still further, the inventors' non-random initialization of the task-oriented layer leads to a better model because, inter alia, (1) the initialized parameters are close to the optimal solution, which reduces the training time and (2) the approximate solution is based on shared covariance matrix statistics and class centroid statistics, which have much smaller variance between training and testing datasets.

As the foregoing also illustrates, the techniques may reduce the amount of time used to train the DNNs for a particular purpose, such as for image recognition and/or object detection. The decreased training time may lead to an increase in the implementation and usage of the DNNs in performing such tasks in distributed computing environments.

As the foregoing further illustrates, one or more embodiments of the present invention can advantageously increase the level of engagement between a user and a DNN, especially over the Internet.

As the foregoing further illustrates, because the class conditional distributions in DNN feature space have the tendency of being exponential family distribution with shared high order statistics, a variant of the linear discriminant analysis algorithm is provided to initialize the task specific last layer of a neural network.

Although selected embodiments of the present invention have been shown and described individually, it is to be understood that at least aspects of the described embodiments may be combined. Also, it is to be understood the present invention is not limited to the described embodiment(s). Instead, it is to be appreciated that changes may be made to the one or more disclosed embodiments without departing from the principles and spirit of the invention, the scope of which is defined by the claims and the equivalents thereof. It should be understood that the subject matter defined in the appended claims is not necessarily limited to the specific implementations described above. The specific implementations described above are disclosed as examples only.

What is claimed is:

1. A method of training a deep neural network, comprising:
inputting training data into a deep neural network comprising multiple layers that are parameterized by a plurality of parameters, the multiple layers including:
an input layer that receives training data;
an output layer from which output is generated in a manner consistent with one or more classification tasks; and
at least one hidden layer that is interconnected with the input layer and the output layer, that receives output from the input layer, and that outputs transformed data to a feature space between the at least one hidden layer and the output layer;
evaluating a distribution of the data in the feature space; and
initializing, non-randomly, the parameters of the output layer based on the evaluated distribution of the data in the feature space.

2. The method of claim 1, wherein the initializing the parameters comprises estimating parameter values of the output layer by finding an approximate solution to each classification task.

3. The method of claim 1, wherein results of the initializing are close to the optimal solution to each classification task.

4. The method of claim 1, wherein the initializing the parameters comprises:
approximating a distribution of features for each classification task; and
deriving an optimal linear classifier, based results of the approximating, the optimal linear classifier being usable to initialize the parameters of the output layer of the DNN model.

5. The method of claim 4, wherein each distribution is Gaussian, shares a same covariance, and does not share a same mean.

6. The method of claim 4, wherein the approximating is based on at least one of class centroid statistics and shared covariance matrix statistics.

7. The method of claim 1, wherein:
the at least one hidden layer comprises a plurality of hidden layers;
each hidden layer comprises a respective plurality of nodes, each node in a hidden layer being configured to perform a transformation on output of at least one node from an adjacent, lower layer;
a lowest one of the plurality of hidden layers receives an output from the input layer; and
the output layer receives an output from a highest one of the plurality of hidden layers.

8. The method of claim 1, further comprising initializing the one or more of the hidden layers using estimates and/or solutions from general training models.

9. A method of computing initializing parameters of a task-specific layer of a deep neural network comprising: a task-specific layer from which output is generated in a manner consistent with one or more classification tasks; and at least one hidden layer that is connected to the output layer and that outputs transformed data to a feature space between the at least one hidden layer and the task-specific layer, the method comprising:
determining one or more tasks of the task-specific layer; and
estimating initializing values for parameters of the task-specific layer by finding an approximate solution to each of the one or more classification tasks, based on the data distribution in the feature space.

10. The method of claim 9, wherein the resolving includes:
approximating a distribution of the features for each class of data, the distributions having Gaussian distributions and a shared covariance;
deriving a linear classifier based on the distribution; and
calculating initializing parameters of the last layer of the DNN model using the derived linear classifier.

11. The method of claim 10, wherein the linear classifier is an optimal solution.

12. The method of claim 10, wherein the determining is based on how data is distributed in the feature space.

13. The method of claim 10, further comprising introducing a regularization term to a covariance matrix so as to minimize variability of covariance matrix estimation in the absence of sufficient training data.

14. A system comprising:
an artificial neural network, comprising:
an input level of nodes that receives the set of features and applies a first non-linear function to the set of features to output a first set of modified values;
a hidden level of nodes that receives the first set of modified values and applies an intermediate non-linear function to the first set of modified values to obtain a first set of intermediate modified values;
an output level of nodes that receives the first set of intermediate modified values, and generates a set of output values, the output values being indicative of a pattern relating to a classification task of the output level; and
level initializing logic that non-randomly initializes the parameters of the output level by resolving approximate solutions to the last layer, based on data distribution in the feature space.

15. The system of claim 14, wherein the level initializing logic initializes the parameters of the hidden level using values from general training models.

16. The system of claim 14, wherein the level initializing logic is a first level initializing logic, wherein the system further comprises a second level initializing logic that initializes the parameters of the hidden level using values from general training models.

17. The system of claim 14, wherein the approximate solutions are resolved via result of a variant of a linear discriminant analysis algorithm.

18. The system of claim 14, wherein the output level initializing logic estimates parameter values of the output level by:
finding an approximate solution to each classification task;
approximating a distribution of features for each classification task; and
deriving an optimal linear classifier, based on results of the approximating, the optimal linear classifier being usable to initialize the parameters of the output layer of the DNN model.

19. The system of claim 18, wherein each distribution is Gaussian, shares a same covariance, and does not share a same mean, or wherein each approximate solution is based on at least one of class centroid statistics and shared covariance matrix statistics.

20. A system comprising one or more computing devices and one or more storage devices storing instructions that are operable, when executed by the one or more computing devices, to cause the one or more computing devices to perform the method of claim 9.
